(19) United States
(12) Patent Application Publication
(10) Pub. No.: US 2026/0320859 A1
(43) Pub. Date: Oct. 15, 2026

(54) METHOD, APPARATUS, ELECTRONIC DEVICE, AND STORAGE MEDIUM FOR IMAGE GENERATION

(71) Applicant: Beijing Zitiao Network Technology Co., Ltd., Beijing (CN)

(72) Inventors: Jing WANG, Beijing (CN); Wang MIAO, Beijing (CN); Yuyang XU, Beijing (CN); Dingding XU, Beijing (CN); Songwei LIU, Beijing (CN)

(21) Appl. No.: 19/117,336

(22) PCT Filed: Nov. 17, 2023
(86) PCT No.: PCT/CN2023/132440

§ 371 Date: Mar. 31, 2025

(30) Foreign Application Priority Data
Nov. 18, 2022 (CN) 202211449865.7

(51) Int. Cl. G06T 11/60; G06V 10/70; G06V 10/74; G06V 40/16

(52) U.S. Cl. CPC G06T 11/60; G06V 10/761; G06V 10/768; G06V 40/161; G06V 40/171; G06T 2210/22

(57) ABSTRACT

Provided are a method, an apparatus, an electronic device, and a storage medium for image generation. The method includes: obtaining at least two initial images; performing image style migration respectively on the at least two initial images to obtain corresponding target image frames each having a target image style; and combining at least two target image frames according to a target stitched image layout, so as to generate a target stitched image; the target stitched image layout is determined based on image content of at least two initial images in initial image data.

This application claims priority to Chinese Patent Application No. 202211449865.7, filed on Nov. 18, 2022, entitled “METHOD, APPARATUS, ELECTRONIC DEVICE, AND STORAGE MEDIUM FOR IMAGE GENERATION”, the disclosure of which is incorporated herein by reference in its entirety.

### FIELD

Embodiments of the present disclosure relate to the field of image generation technologies, and in particular, to a method, an apparatus, an electronic device, and a storage medium for image generation.

### BACKGROUND

At present, taking an application scenario created by video content as an example, a user needs to generate a corresponding image as a video front cover based on video data, so as to achieve the purpose of previewing and presenting the video content. In prior arts, a certain video frame in a video is usually extracted based on a manual selection by the user to generate the aforementioned video cover.

However, in prior arts, an image generated by video data has problems such as a small amount of image information and a poor visual expression.

### SUMMARY

Embodiments of the present disclosure provide a method, an apparatus, an electronic device, and a storage medium for image generation, so as to overcome problems of a small amount of image information and poor visual performance in generated images.

According to a first aspect, an embodiment of the present disclosure provides a method for image generation, including:
obtaining at least two initial images, and performing image style migration respectively on the at least two initial images to obtain corresponding target image frames each having a target image style; determining a target stitched image layout according to image content corresponding to the at least two initial images; and combining the at least two target image frames according to the target stitched image layout to generate a target stitched image.

According to a second aspect, an embodiment of the present disclosure provides an apparatus for image generation, including:
an obtaining module configured to obtain at least two initial images;
a migration module configured to perform image style migration respectively on the at least two initial images to obtain corresponding target image frames each having a target image style; and
a combination module configured to determine a target stitched image layout according to image contents corresponding to the at least two initial images, and combine the at least two target image frames according to the target stitched image layout to generate a target stitched image.

According to a third aspect, an embodiment of the present disclosure provides an electronic device, including:
a processor and a memory communicatively connected to the processor;
the memory stores computer execution instructions;
the processor executes the computer execution instructions stored in the memory, so as to implement the method for image generation according to the above first aspect and various possible designs of the first aspect.

According to a fourth aspect, an embodiment of the present disclosure provides a computer readable storage medium. The computer readable storage medium stores a computer execution instruction therein. When executed by a processor, the computer execution instructions implement the method for image generation according to the first aspect and various possible designs of the first aspect.

According to a fifth aspect, an embodiment of the present disclosure provides a computer program product, including a computer program which, when executed by a processor, implements the method for image generation according to the first aspect and various possible designs of the first aspect.

According to the method, the apparatus, the electronic device and the storage medium for image generation, at least two initial images are obtained, and image style migration are respectively performed on the at least two initial images to obtain corresponding target image frames each having a target image style; then a target stitched image layout is determined according to image content corresponding to the at least two initial images; and the at least two target image frames are combined according to the target stitched image layout to generate a target stitched image. Because the target image frames having a specific image style are obtained by performing the style migration on the at least two initial images and then arrangement and combination are performed on the target image frames to obtain a target stitched image having a layout matching the content of the plurality of initial images, in this way, the target stitched image can not only present the multi-frame images with a style, but also present the association of a plurality of frames of images with the style through the stitched image layout, thereby, effective information in a plurality of frames of initial images is fully displayed, and visual expression is improved.

### BRIEF DESCRIPTION OF THE DRAWINGS

To describe the technical solutions in the embodiments of the present disclosure or in prior arts more clearly, the following briefly introduces the accompanying drawings required for describing the embodiments or the prior arts. Apparently, the accompanying drawings in the following description are described in connection with some embodiments of the present disclosure, other drawings may also be obtained according to these drawings without creative efforts.

FIG. 1 is a diagram of an application scenario for a method for image generation according to an embodiment of the present disclosure;

FIG. 2 is a first schematic flowchart of a method for image generation according to an embodiment of the present disclosure;

FIG. 3 is a flowchart of a specific implementation of step S102 in the embodiment shown in FIG. 2;

FIG. 4 is a flowchart of a specific implementation of step S1022 in the embodiment shown in FIG. 3;

FIG. 5 is a schematic diagram of determining a first image frame according to an embodiment of the present disclosure;

FIG. 6 is a schematic diagram of a target stitched image layout for a target stitched image according to an embodiment of the present disclosure;

FIG. 7 is a second schematic flowchart of a method for image generation according to an embodiment of the present disclosure;

FIG. 8 is a schematic diagram of cropping an image according to an embodiment of the present disclosure;

FIG. 9 is a flowchart of a specific implementation of step S206 in the embodiment shown in FIG. 2;

FIG. 10 is a flowchart of a specific implementation of step S208 in the embodiment shown in FIG. 2;

FIG. 11 is a structural block diagram of an apparatus for image generation according to an embodiment of the present disclosure;

FIG. 12 is a schematic diagram of a structure of an electronic device according to an embodiment of the present disclosure;

FIG. 13 is a schematic structural diagram of hardware of an electronic device according to an embodiment of the present disclosure.

### DETAILED DESCRIPTION

In order to make objects, technical solutions, and advantages of the embodiments of the present disclosure more apparent, the technical solutions in the embodiments of the present disclosure will be described below in a clearly and fully understandable way in connection with the drawings related to the embodiments of the present disclosure. Obviously, the described embodiments are only a part but not all of the embodiments of the present disclosure. All other embodiments obtained by those skilled in the art based on the embodiments of the present disclosure without creative efforts shall belong to the scope of protection of the present disclosure.

Application scenarios of the embodiments in the present disclosure will be explained below:

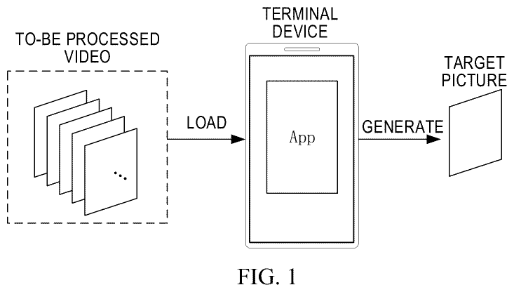

FIG. 1 is a diagram of an application scenario for a method for image generation according to an embodiment of the present disclosure. The method for image generation according to the embodiment of the present disclosure can be applied to application scenarios of video image editing processing such as video cover generation and conversion of a video to a picture set. Specifically, taking an application scenario of generating a video cover as an example, the method provided by embodiments of the present disclosure can be applied to a terminal device or a server; and taking the method being applied to a terminal device as an example, a video editing application (APP) runs in the terminal device. As shown in FIG. 1, after a user obtains a to-be-processed video via photographing, downloading from a server, or receiving from another terminal device and the like, the to-be-processed video is loaded to a video editing application (shown as App in the drawing) on which the method for image generation provided by embodiments of the present application is applied. Then, after processing the to-be-processed video using the video editing application, the terminal device generates, based on video content in the to-be-processed video, a target picture capable of expressing the video content, so that the target picture is used as a video cover of the to-be-processed video.

In prior arts, by taking an application scenario in which a video cover is made during a video content creation process as an example, through operating a terminal device by a user, a corresponding image is generated based on video data as a video cover, so as to achieve the objectives of previewing and presenting the video content. In prior arts, generally, the above image is generated by extracting a certain video frame from a video in a manner of a manual selection by a user. However, video data includes multiple frames of images, the image content of each frame is different. Taking only one of the frames as the video front cover cannot fully express the video data, and there would be a problem of insufficient image information. At the same time, using an initial image frame in the video data as the video cover, compared with the display method of continuous playback of the video content of the video data, would result in the video cover failing to highlight the focus of the video content, affecting the visual expression and the information expression capability.

In addition, in other image processing application scenarios to which the method of the embodiments are applicable, for example, converting a video into one or more pictures and generating a stitched image using a picture set, the above problems are also faced.

An embodiment of the present disclosure provides a method for image generation to solve the described problem.

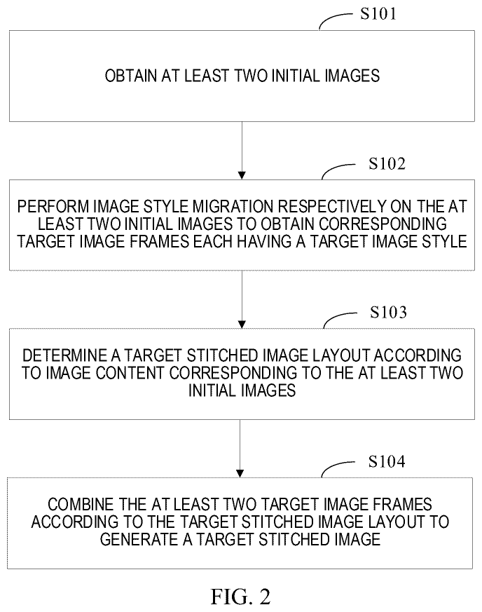

Referring to FIG. 2, which is a first schematic flowchart of a method for image generation according to an embodiment of the present disclosure. The method of this embodiment may be applied to a terminal device, and the method for image generation includes:
Step S101: obtaining at least two initial images.

As an example, the initial image is an image used as a material of the target stitched image, and the initial image may be obtained by performing frame extraction from the material data. The material data may be a video, or a picture set, or a set of both. Taking the material data as a video as an example, referring to the schematic diagram of the application scenario shown in FIG. 1, the material data corresponds to the to-be-processed video in the embodiment shown in FIG. 1. The material data may be obtained by the user through an image acquisition unit of the terminal device, such as a camera. It may also be obtained by accessing a server for downloading, or by receiving data sent by other terminal devices. This may be set as needed, and will not be repeated in detail.

The material data includes at least two frames of material images. Taking the material images as video data as an example, the material data (video data) consists of a plurality of video frames (material images). By decoding the initial image data, the video frames constituting the initial image data may be obtained. Then, based on a preconfigured rule, the video frames (material images) in the material data are screened to obtain an image which meets the requirements of the rule, i.e., an initial image, for example, a key frame (I-frame) in the material data is used as an initial image. The method for determining and retrieving a key frame in video data belongs to the prior art, and will not be repeated herein.

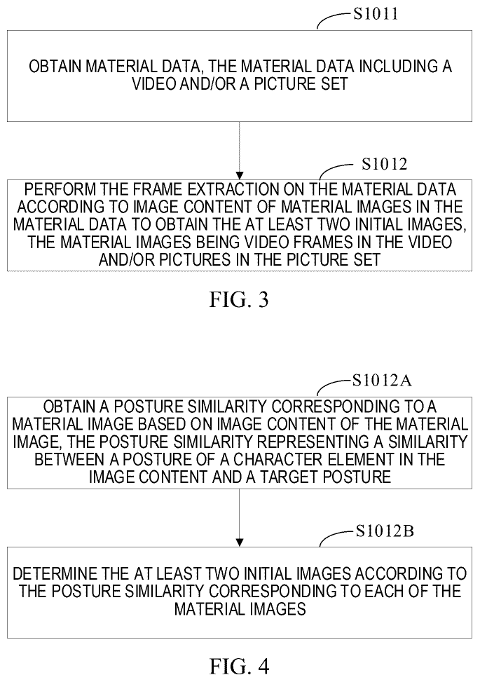

In another possible implementation, frame extraction may be performed on the initial material data based on the content of the material data, so as to obtain an initial image of the material for generating a subsequent target stitched image. As an example, as shown in FIG. 3, a specific implementation of step S101 includes:

At step S1011, obtaining material data, and the material data includes a video and/or a picture set;

At step S1012, performing the frame extraction on the material data according to image content of material images in the material data to obtain the at least two initial images, the material images being video frames in the video and/or pictures in the picture set.

As an example, after obtaining the material data, image recognition is first performed on each material image in the material data to obtain the image content of each material image, where there are a plurality of specific implementations for the image content, for example, it may be a feature matrix (feature) that describes image content, it may also be a pixel matrix that describes image content, and it may also be an identifier that characterizes particular content in an image. More particularly, for example, when a portrait is included in the image, the corresponding identifier (image content) is #001, and when a landscape is included in the image, the corresponding identifier (image content) is #002.

Further, the content may be further subdivided on this basis, so as to obtain a more refined identifier, for example, when an image includes a portrait, the corresponding identifier (image content) is #001_1; when the image includes two portraits, the corresponding identifier (image content) is #001_2. The specific representation manner of the identifier for representing the specific content in the material image and the mapping relationship between the identifier and the specific content in the image can be configured based on needs and will not be described one by one herein.

Further, after obtaining image content corresponding to each of the material images, screening is performed according to image content corresponding to the material images, and at least two image frames, i.e., initial images, that are key and better express the material data are determined therein, so as to generate a target stitched image. In a possible implementation, as shown in FIG. 4, a specific implementation of step S1012 includes:

At step S1012A, a posture similarity corresponding to a material image is obtained based on image content of the material image, where the posture similarity represents a similarity between a posture of a character element in the image content and a target posture.

At Step S1012B, at least two initial images are determined according to the posture similarity corresponding to each of the material images.

As an example, after each material image is identified, image content of the material image is obtained. In this embodiment, the image content includes a character element, where the character element refers to an image element related to a portrait, for example, a head, a torso, a limb, and a hand in the portrait, and the portrait as a whole. In image content of a material image, a character element presents different postures, and a posture similarity is obtained by comparing a posture of the character element in the image content with a pre-set target posture, where the more consistent the posture of the character element in the image content of the material image is with the target posture, the higher the posture similarity is; in contrast, the lower the posture similarity is. The specific method for calculating the posture similarity may be implemented based on an image consistency algorithm. The image consistency algorithm is a prior art known to a person skilled in the art, and will not be described herein again. The posture of the character element includes, for example, one or more of a facial expression, a limb movement and a torso movement, and a hand movement.

In the present embodiment, the purpose of obtaining the posture similarity corresponding to each material image is to evaluate whether the material image can represent important content in the material data, so as to be screened as an initial image which will be used as a material of a subsequently generated target stitched image. The target posture includes a plurality of pre-set postures of a character element, for example, a face smiling expression, a face laughing expression, and a limb movement when a hand is waved. The target posture may serve as a rule for determining whether the posture of the character element can express effective information (for example, whether the happy and angry mood can be expressed), and whether the posture complies with aesthetic features. Therefore, by comparing the similarity between the posture of the character element in the image content of the respective material images and the target posture, obtaining a posture similarity corresponding to each initial image, and then screening image content of respective initial images based on the posture similarities, the character posture is more meaningful and more compliant with aesthetic features, so that a subsequently generated target image frame and target stitched image can express more abundant and effective information, and the portrait in the image is more beautiful. Still further, in a possible implementation, a specific implementation of determining at least two initial images according to a posture similarity corresponding to each of the material images includes:
determining a material image with a posture similarity greater than a first similarity threshold as the initial image, and/or determining a material image with a posture similarity less than a second similarity threshold as the initial image; the first similarity threshold is greater than the second similarity threshold.

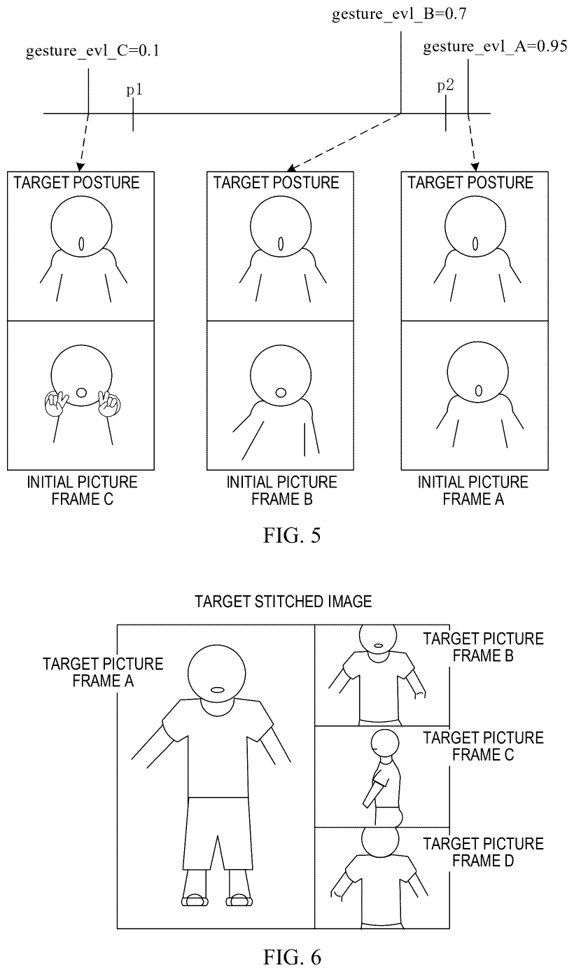

FIG. 5 is a schematic diagram of determining an initial image according to an embodiment of the present disclosure. The process of determining at least two initial images in the above steps will be described below with reference to FIG. 5. As shown in FIG. 5, the posture similarity, the first similarity threshold and the second similarity threshold are all normalized values. When the posture similarity is equal to 1, it indicates that they are completely consistent; and when the posture similarity=0, it indicates that they are completely inconsistent, and the first similarity threshold is greater than the second similarity threshold. Specifically, for example, the first similarity threshold (shown as p1 in the drawing) is 0.9; the first similarity threshold (shown as p2 in the drawing) is, for example, 0.2. The image content of the material image A, the image content of the material image A and the image content of the material image C are processed respectively based on the target posture, a posture similarity gestureev1_A corresponding to the material image A equals to 0.95, a posture similarity gestureev1_B corresponding to the material image B equals to 0.7, and a posture similarity gesture_ev1_C corresponding to the material image C equals to 0.1. On the one hand, the posture similarity gesture_ev1_A corresponding to the material image A being equivalent to 0.95 satisfies the condition of being greater than the first similarity threshold value (gesture_ev1_A>0.9), that is, the posture of the character element corresponding to the material image A is very close to the target posture, and therefore the posture of the character element corresponding to the material image A is regarded as the target posture, and thus, the initial image A is determined as an initial image. On the other hand, the posture similarity gesture_ev1_C corresponding to the material image C being equivalent to 0.1 satisfies the condition of being less than the second similarity threshold value (gesture_ev1_C <0.2), that is, the posture of the character element corresponding to the material image C differs greatly from the target posture, and in this case, it is considered that the posture of the portrait in the material image is a purposively designed posture of the user; although there is a possibility that the portrait does not conform to the aesthetic feature (since the posture is greatly different from the target posture), since the posture contains a large amount of information, the initial image C is also determined as an initial image. The posture similarity gestureev1_B corresponding to the material image B being equivalent to 0.8 does not satisfy the condition of being less than a second similarity threshold value, or the condition of being greater than the first similarity threshold (0.2<gesture_ev1_B<0.9), in this case, the posture corresponding to the material image B is considered to be a degraded target posture, which cannot satisfy the requirements of aesthetic features, and at the same time, since it is close to the target posture, but is insufficient to represent a sufficient amount of information, the material image B is discharged instead of being taken as an initial image.

In the steps of the present embodiment, the posture similarities of the material images are obtained, and based on the magnitudes of the posture similarities, an initial image which is greater than a first similarity threshold value and/or less than a second similarity threshold value is determined as an initial image. Thus, it is ensured that the first image frame can contain a large amount of information and also take account of aesthetic features, thereby fully displaying data content in the material data, increasing the amount of information and the image appearance of a target image frame and a target stitched image subsequently generated.

At Step S102, image style migration is performed respectively on the at least two initial images to obtain corresponding target image frames each having a target image style.

As an example, after at least two initial images are obtained, the image style migration is respectively performed on the plurality of initial images. For example, the material data includes 30 key frames in total, and the 30 key frames are used as initial images, and the image style migration is respectively performed on the 30 key frames, so as to obtain 30 corresponding image frames each having a specific identical image style (target image style), i. e. target image frames. The image style migration refers to adding an image style special effect to an image, so that the processed image has a certain image drawing style in terms of color and lines, for example, an oil-painting style, a cartoon style, a sketch style, and the like. In a specific implementation, for example, by means of a pre-trained style migration model capable of implementing a target image style, the initial images are respectively processed, so as to obtain images each having the target image style, i. e. a target image frames. Specific training and using methods of the style migration model are known to persons skilled in the art, and will not described herein again.

At step S103, a target stitched image layout is determined according to image content corresponding to the at least two initial images.

At step S104, at least two target image frames are combined according to a target stitched image layout to generate a target stitched image.

As an example, after at least two target image frames are obtained, the target image frames are spliced and combined to obtain an image following a certain layout rule, that is, a target stitched image. As an example, the target stitched image includes at least two stitched image areas, each of the stitched image areas is configured to display one corresponding target image frame, and the target stitched image layout represents sizes and/or positions of the stitched image areas in the target stitched image. FIG. 6 is a schematic diagram of a target stitched image layout of the target stitched image according to an embodiment of the present disclosure. As shown in FIG. 6, the target stitched image is consisted of four target image frames, i. e. a target image frame A, a target image frame B, a target image frame C and a target image frame D, where each target image frame corresponds to a stitched image area, and the stitched image area corresponding to the target image frame A is relatively large, and located on the left side of the target stitched image, and the stitched image areas corresponding to the target image frame B, the target image frame C and the target image frame D are relatively small, and located to the right of the target stitched image.

The target stitched image layout of the target stitched image is not randomly generated, but is determined based on the image content of respective initial images. In a possible implementation, the step of generating the target stitched image layout includes:

At step S103A, layout information is obtained according to image content corresponding to the at least two initial images in initial image data, and the layout information represents the size and/or position of each of the stitched image areas in the target stitched image.

At step S103B, a target stitched image layout is generated according to the layout information.

As an example, the foregoing steps are performed before step S103. Specifically, for example, refer to the target stitched image shown in FIG. 6, the initial image data is a segment of video data for introducing clothes dressing, and in a frame of each target image frame obtained based on the initial images in the initial image data, the image content of the target image frame A corresponds to the portrait as a whole (the character element, hereinafter the same), and is located at the most significant major position on the left side of the target stitched image, so as to express the clothes dressing effect of the character as a whole. The image content of the target image frame B corresponds to the front of the portrait, the image content of the target image frame C corresponds to the back of the portrait, and the image content of the target image frame D corresponds to a side of the portrait, all of them are located at secondary positions on the right side of the target stitched image for representing the clothes dressing effect of a character on front, back and side. Thus, the target stitched image can achieve the display of important content information (front, back, side and overall effect of the clothes dressing) in the video data (initial image data), increasing the amount of information of the target stitched image.

Further, a method for obtaining image content of each target image frame has been introduced in the previous steps. In a possible implementation, ranking can be performed based on posture similarity degrees of target image frames with respect to target postures or based on significant degrees of aesthetic features, so as to determine the areas and positions of stitched image areas corresponding to respective target video frames, thereby determining a target stitched image layout.

In this embodiment, at least two initial images are obtained, and image style migration are respectively performed on the at least two initial images to obtain corresponding target image frames each having a target image style; a target stitched image layout is determined according to image content corresponding to the at least two initial images; and at least two target image frames are combined according to the target stitched image layout to generate a target stitched image. Because target image frames having a specific image style are obtained by performing style migration on at least two initial images, then arrangement and combination are performed on the target image frames, so as to obtain a target stitched image having a layout matching the content of the plurality of initial images. In this way, the target stitched image can not only display the multi-frame images with a style effect, but also display content association of a plurality of frames of images with the style effect through the stitched image layout, thereby, effective information in a plurality of frames of initial images is fully displayed, and visual performance is improved.

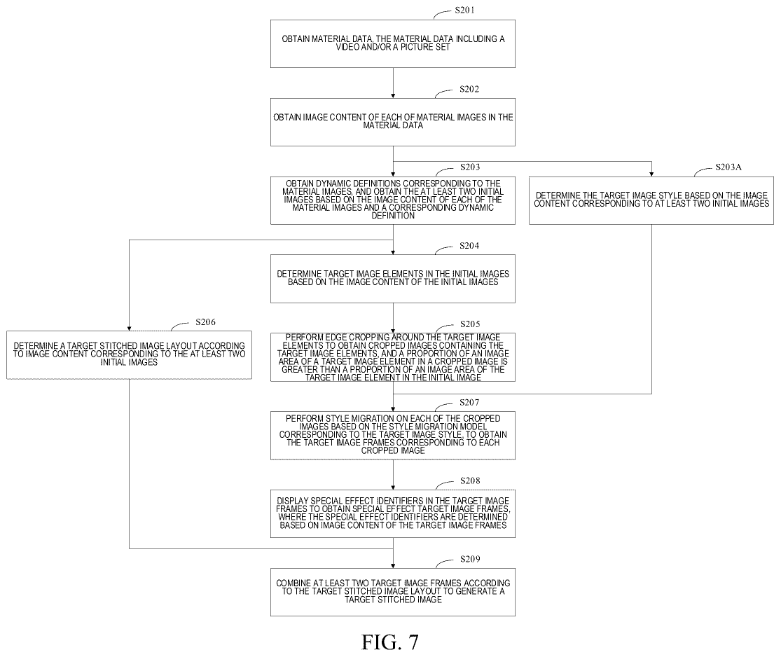

Referring to FIG. 7, FIG. 7 is a second schematic flowchart of a method for image generation according to an embodiment of the present disclosure. On the basis of the embodiment shown in FIG. 2, this embodiment further details step S102 and adds a step of determining a target stitched image layout. The method for image generation includes:

At step S201, material data is obtained, where the material data includes a video and/or a picture set.

At step S202, the image content of each material image in the material data is obtained.

Specific implementations of steps S201 to S202 of this embodiment have been described in detail in the embodiment shown in FIG. 2, and are not described herein again.

At step S202, dynamic definitions corresponding to the respective material images are obtained, and at least two initial images are obtained based on the image content of each material image and the corresponding dynamic definition.

As an example, in the case of obtaining material images, definition detection may be further performed on each material image to obtain a corresponding dynamic definition, where the dynamic definition refers to a screen definition when the dynamic image is played, and specifically it indicates whether a phenomenon such as “trailing” or “ghost” appears in the dynamic screen. The definition detection may be obtained by performing correlation analysis on an image. Specifically, for example, the image is divided into several transverse or longitudinal areas, and then correlation between adjacent areas is calculated. If phenomena such as “trailing” and “ghost” exist, that is, when the dynamic definition is relatively low, the correlation is relatively high, otherwise, the correlation is relatively low. Accordingly, the corresponding dynamic definition is obtained based on the correlation calculation. Certainly, there are other possible implementations for the dynamic definition, which are not repeatedly described herein.

Further, after obtaining the dynamic definitions corresponding to the material images, various material images are screened based on the dynamic definitions while screening the material images based on the image content of the material images, and images with low dynamic definitions therein are removed, and images with higher dynamic definitions are reserved as the initial images, thereby improving the image definitions of the initial images, improving the visual effect of a subsequently generated target image frame. The implementation of screening respective material images based on the image content of the material images has been described in detail in the embodiment shown in FIG. 2, and will not be repeated herein.

Optionally, this embodiment further includes:

At step S203A, a target image style is determined based on image content corresponding to thet least two initial images.

As an example, the target image style refers to a type of a certain image style effect, for example, an oil-painting style, a cartoon style, a sketch style, and the like. There are various methods for determining a target image style, for example, determining a corresponding target image style by means of pre-set configuration information; for another example, a target image style is determined based on data content of the initial image data, and the image content corresponding to the at least two initial images refers to image content respectively corresponding to the at least two initial images and association between respective pieces of image content. In a possible implementation, the image content corresponding to the at least two initial images may be determined according to content of material data corresponding to the initial images. The theme and type of the content expressed by the image content corresponding to thet least two initial images may be represented by a specific content identifier, for example, the content identifier being #1 represents that the at least two initial images are user's selfie videos; the content identifier being #2 represents that the at least two initial images are short videos; and the content identifier being #2 represents that the at least two initial images are movies. The specific implementation and expression of the content identifiers may be set as required, and will not be repeated here. Further, there is a pre-set mapping relationship between the image content corresponding to the at least two initial images and a target image style, for example, when the image content corresponding to the at least two initial images is a portrait selfie video, the corresponding target image style is a cartoon style; and when the image content corresponding to the at least two initial images is a short video, the corresponding target image style is a sketch style. In this embodiment, a corresponding target image style is determined according to the image content corresponding to the at least two initial images and content correlation between the image content corresponding to thet least two initial images, so that an image style of the generated target image frame matches the image content corresponding to the at least two initial images, thereby improving a visual performance of the target image frame.

At step S204, target image elements in the initial images are determined based on image content of the initial images.

At step S205, edge cropping is performed around a target image element to obtain a cropped image containing the target image element, where the target image elements to obtain cropped images containing the target image elements, where a proportion of an image area of a target image element in a cropped image of the cropped images is greater than a proportion of an image area of the target image element in the corresponding initial image.

As an example, after an initial image is obtained, a screen composition of the initial image is the same as that of a material image, and after the initial image is independently extracted from the material data, due to lack of expression of changes in a previous image frame and a next image frame, a problem of failing to highlight the focus of the image may occur.

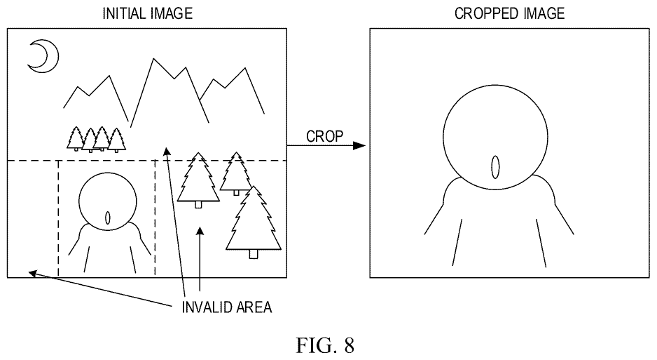

In order to solve the described problem, in the present embodiment, a target image element in an initial image is determined based on an image content of the initial image, for example, the image content of the initial image is a portrait selfie, a portrait contour therein is used as a centre to perform clipping around, invalid areas in a first image frame are cut off, and a cropped image containing the portrait contour (the target image element) is obtained. FIG. 8 is a schematic diagram of a cropped image according to an embodiment of the present disclosure. As shown in FIG. 8, an initial image includes a portrait, and after invalid areas outside the portrait are cropped based on a portrait contour, the obtained image frame including the portrait, that is, the cropped image is obtained. Since the invalid areas in the first image frame are cropped, a ratio of a portrait contour (target image element) in the cropped image is higher than a ratio of the portrait contour in the initial image. Thus, the purpose of highlighting a focus in the screen is achieved, and the visual performance of the target image frame is improved. At the same time, an initial image is cropped to obtain the tailored image, the invalid image areas are reduced, and the image migration efficiency in a subsequent style migration process can be increased.

At step S206: a target stitched image layout is determined according to the image content corresponding to the at least two initial images.

Further, after image content of the initial images is obtained, the image content of the initial images can be evaluated based on a certain rule, and a target stitched image layout is generated according to an evaluation result, so that a first image frame with a higher amount of information and/or a higher aesthetic level can be displayed preferentially. According to a specific implementation, the first image frame is evaluated and sorted based on, for example, the posture similarity and aesthetic features corresponding to the image content, so that a target stitched image layout is generated. The specific implementation method has been introduced in the corresponding paragraphs of the embodiment shown in FIG. 2, and will not be repeated herein.

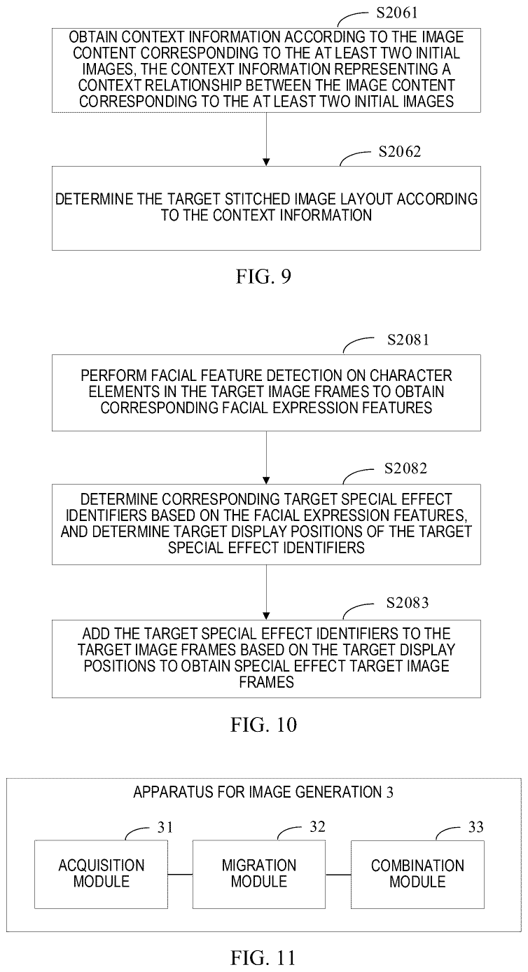

In a possible implementation, as an example, as shown in FIG. 9, a specific implementation of step S206 includes:

At step S2061, context information is obtained according to the image content corresponding to the at least two initial images, where the context information represents a context relationship between the image content corresponding to the at least two initial images.

At step S2062, the target stitched image layout is determined according to the context information.

As an example, the initial images are the result of screening material images in the initial image data, that is, the initial images are specific material images. Different initial images have content continuity therebetween, for example, material data corresponding to the initial images is a segment of “dance” video, that is there is a timing relationship between dance actions corresponding to respective material images in a video. There is also such a temporal association between the initial images screened from the material images, i. e., a contextual association. More specifically, e. g., 100 initial images are obtained based on previous steps, and then semantic recognition is performed on each of the initial images to obtain semantic information which corresponds to each of the initial images and represents a dance action; based on the semantic information corresponding to respective ordered initial images, context information is generated, and the context information may be a feature matrix representing an association between the semantic information, then, based on context information, initial images corresponding to repetitive dance actions and insignificant dance actions are screened to obtain the number of first image frames (e. g., ten) which represent only significant and non-repetitive dance actions, and an importance evaluation value indicative of the importance of the dance actions; In addition, the number of the stitched image areas in the target stitched image layout and the corresponding sizes and positions of the initial images (i.e., layout information) are determined.

In the present embodiment, by obtaining context information and determining a target stitched image layout based on the context information, the information in the initial image data is fully used, so that the target stitched image layout of the generated target stitched image is more reasonable, the important information in the initial image data can be better reflected, and the display effect is improved.

At step S207, style migration is performed on each of the cropped images based on a style migration model corresponding to the target image style, to obtain a target image frame corresponding to each of the cropped images.

At step S207, special effect identifiers are displayed in the target image frames to obtain special effect target image frames, where the special effect identifiers are determined based on image content of the target image frames.

As an example, after the style migration is performed on the cropped images to obtain the target image frames, dynamic feature identifiers, such as “firework collage effect” and “virtual decoration effect”, may further be added to the target image frames, so as to further improve the visual performance of the target stitched image.

As an example, as shown in FIG. 10, specific implementation steps of step S208 include:

At step S2081, facial feature detection is performed on the character elements in the target image frames to obtain corresponding facial expression features.

At step S2082, a corresponding target special effect identifiers is determined based on the facial expression feature, and the target display positions of the target special effect identifiers are determined.

At step S2083, target special effect identifiers are added to the target image frames based on the target display positions to obtain special effect target image frames.

As an example, this embodiment is applicable to a scenario in which a target image frame contains a character element. Specifically, each element in the target image frame is first identified to obtain a character element, for example, a face of a portrait, and then facial feature detection is performed on the character element to obtain a facial expression feature, for example, including: happiness, sadness, and the like. Then, based on the facial expression features, corresponding target special effect identifiers are determined; and based on the position of each element in the target image frame, target display positions of the target special effect identifiers are determined, so that the target special effect identifiers avoid other image elements, thereby avoiding blocking. Finally, the target special effect identifiers are loaded at the target display positions of the target image frames to obtain special effect target image frames.

At step S209, at least two special effect target image frames are combined according to a target stitched image layout to generate a target stitched image.

Specific implementations of steps S207 and S209 in this embodiment have been described in detail in the embodiment shown in FIG. 2, and will not be described herein again.

Corresponding to the method for image generation in the above embodiments, FIG. 11 is a block diagram of an apparatus for image generation according to an embodiment of the present disclosure. For convenience of explanation, only parts related to the embodiment of the present disclosure are illustrated. Referring to FIG. 11, the apparatus for image generation 3 includes:
an obtaining module 31 configured to obtain at least two initial images;
a migration module 32 configured to perform image style migration respectively on the at least two initial images to obtain corresponding target image frames each having a target image style; and
a combination module 33 configured to determine a target stitched image layout according to image content corresponding to the at least two initial images, and combine the at least two target image frames according to the target stitched image layout to generate a target stitched image.

In a possible implementation, the obtaining module 31 is specifically configured to obtain material data, the material data including a video and/or a picture set; perform frame extraction on the material data according to image content of material images in the material data to obtain the at least two initial images, the material images being video frames in the video and/or pictures in the picture set.

In a possible implementation, when the obtaining module 31 performs frame extraction on the material data according to image content of material images in the material data to obtain the at least two initial images, the obtaining module 31 is specifically configured to obtain a posture similarity corresponding to a material image based on image content of the material image, the posture similarity representing a similarity between a posture of a character element in the image content and a target posture; and determine the at least two initial images according to the posture similarity corresponding to each of the material images.

In a possible implementation, when determining at least two initial images according to the posture similarity corresponding to each of the material images, the obtaining module 31 is specifically configured to determine a material image having a posture similarity greater than a first similarity threshold as the initial image, and/or determine a material image having a posture similarity less than a second similarity threshold as the initial image. The first similarity threshold is greater than the second similarity threshold.

In a possible implementation, the obtaining module 31 is further configured to obtain dynamic definitions corresponding to the material images; when performing frame extraction on the material data according to the image content of the material images in the material data to obtain the at least two initial images, the obtaining module 31 is specifically configured to obtain the at least two initial images based on the image content of each of the material images and a corresponding dynamic definition.

In a possible implementation, the migration module 32 is specifically configured to obtain a style migration model corresponding to the target image style; and process the initial images based on the style migration model, so as to obtain the target image frames corresponding to the initial images.

In a possible implementation, when processing the initial images based on the style migration model to obtain the target image frames corresponding to the initial images, the migration module 32 is specifically configured to determine target image elements in the initial images based on image content of the initial images; perform edge cropping around the target image elements to obtain cropped images containing the target image elements, where a proportion of an image area of a target image element in a cropped image is greater than a proportion of an image area of the target image element in the initial image; perform style migration on each of the cropped images based on the style migration model corresponding to the target image style, to obtain the target image frames corresponding to the initial images.

In a possible implementation, before performing the image style migration respectively on the at least two initial images to obtain the corresponding target image frames each having the target image style, the migration module 32 is further configured to determine the target image style based on the image content corresponding to the at least two initial images.

In a possible implementation, the target stitched image includes at least two stitched image areas, each of the stitched image areas is configured to display one corresponding target image frame, and the target stitched image layout represents sizes and/or positions of the stitched image areas in the target stitched image.

In a possible implementation, when determining the target stitched image layout according to the image content corresponding to the at least two initial images, the combination module 33 is specifically configured to: obtain context information according to the image content corresponding to the at least two initial images, the context information representing a context relationship between the image content corresponding to the at least two initial images; determine the target stitched image layout according to the context information.

In a possible implementation, the combination module 33 is further configured to add special effect identifiers to the target image frames to obtain special effect target image frames, where the special effect identifiers are determined based on image content of the target image frames.

In a possible implementation, when adding the special effect identifiers to the target image frames to obtain special effect target image frames, the combination module 33 is specifically configured to perform facial feature detection on character elements in the target image frames to obtain corresponding facial expression features; determine corresponding target special effect identifiers based on the facial expression features; determine target display positions of the target special effect identifiers; add the target special effect identifiers to the target image frames based on the target display positions, to obtain special effect target image frames.

The obtaining module 31, the migration module 32, and the combination module 33 are connected in sequence. The apparatus for image generation 3 provided in this embodiment can execute the technical solutions of the foregoing method embodiments. The implementation principle and technical effect are similar, and are not repeatedly described herein in this embodiment.

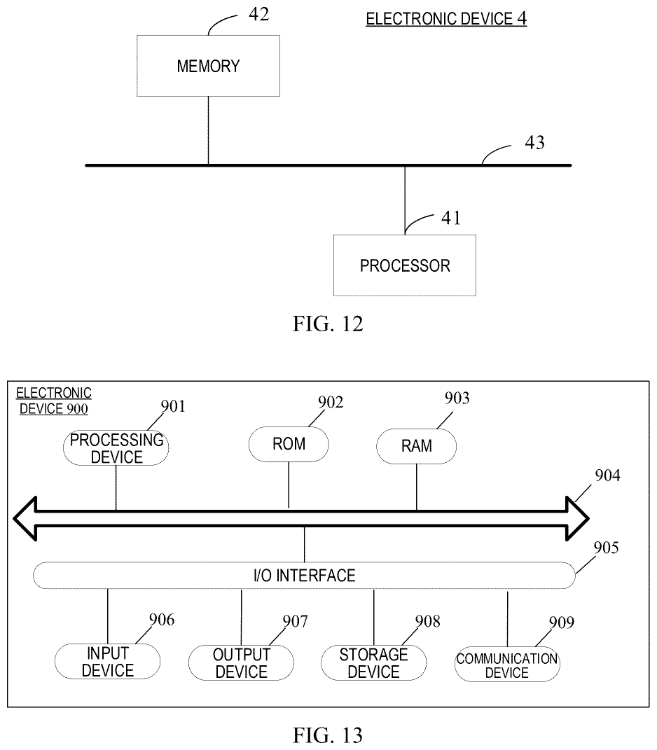

FIG. 12 is a schematic structural diagram of an electronic device according to an embodiment of the present disclosure. As shown in FIG. 12, the electronic device 4 includes:
a processor 41, and a memory 42 communicatively connected to the processor 41;
the memory 42 stores a computer execution instruction;
the processor 41 executes computer-executable instructions stored in the memory 42 to implement the method for image generation in the embodiments shown in FIG. 2 to FIG. 10.

Optionally, the processor 41 and the memory 42 are connected through a bus 43.

The related descriptions can be understood with reference to the related descriptions and effects corresponding to the steps in the embodiments corresponding to FIG. 2 to FIG. 10, and are not repeated herein.

Referring to FIG. 13, it shows a schematic structural diagram of an electronic device 900 suitable for implementing an embodiment of the present disclosure. The electronic device 900 may be a terminal device or a server. The terminal device may include, but is not limited to, a mobile terminal such as a mobile phone, a laptop computer, a digital broadcast receiver, a personal digital assistant (Personal Digital Assistant, PDA for short), a tablet computer (Portable Android Device, PAD for short), a portable multimedia player (Portable Media Player, PMP for short), a vehicle-mounted terminal (for example, a vehicle-mounted navigation terminal), and the like, and a fixed terminal such as a digital TV, a desktop computer, and the like. The electronic device shown in FIG. 13 is merely an example and should not bring any limitation to the functions and scope of use of the embodiments of the present disclosure.

As shown in FIG. 13, the electronic device 900 may include a processing device (such as a central processing unit, graphics processing unit, etc.) 901, which may perform various appropriate actions and processes based on programs stored in Read-Only Memory (ROM for short) 902 or loaded from storage device 908 into Random Access Memory (RAM for short) 903. In the RAM 903, various programs and data necessary for the operation of the electronic device 900 are also stored. The processing device 901, ROM 902, and RAM 903 are connected to each other through a bus 904. An Input/Output I/O interface 905 is also connected to the bus 904.

Typically, the following devices can be connected to I/O interface 905: input devices 906 including, for example, touch screens, touchpads, keyboards, mice, cameras, microphones, accelerometers, gyroscopes, etc. ; output devices 907 including liquid crystal displays (LCD for short), speakers, vibrators, etc. ; storage devices 908 including magnetic tapes, hard disks, etc. ; and a communication device 909. The communication device 909 may allow the electronic device 900 to communicate with other devices wirelessly or wirelessly to exchange data. Although FIG. 13 shows an electronic device 900 with a plurality of devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a computer-readable medium, where the computer program includes program code for performing the method shown in the flowchart. In such an embodiment, the computer program can be downloaded and installed from a network through the communication device 909, or installed from the storage device 908, or installed from the ROM 902. When the computer program is executed by the processing device 901, the above functions defined in the method of the embodiment of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, RF (radio frequency), etc., or any suitable combination thereof.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device execute the method of the above embodiment.

Computer program codes for performing the operations of the present disclosure may be written in one or more programming languages or a combination thereof, including but not limited to Object Oriented programming languages—such as Java, Smalltalk, C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN for short) or wide area network (WAN for short)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case, for example, a first obtaining unit may also be described as “a unit for obtaining at least two internet protocol addresses”.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to a first aspect, in accordance with one or more embodiments of the present disclosure, there is provided a method for image generation, including:
obtaining at least two initial images; performing image style migration respectively on the at least two initial images to obtain corresponding target image frames each having a target image style; determining a target stitched image layout according to image content corresponding to the at least two initial images; and combining at least two target image frames according to the target stitched image layout to generate a target stitched image.

According to one or more embodiments of the present disclosure, obtaining the at least two initial images includes: obtaining material data, the material data including a video and/or a picture set; and performing frame extraction on the material data according to image content of material images in the material data to obtain the at least two initial images, the material images being video frames in the video and/or pictures in the picture set.

According to one or more embodiments of the present disclosure, performing frame extraction on the material data according to the image content of the material images in the material data to obtain the at least two initial images includes: obtaining a posture similarity corresponding to a material image based on image content of the material image, the posture similarity representing a similarity between a posture of a character element in the image content and a target posture; and determining the at least two initial images according to the posture similarity corresponding to each of the material images.

According to one or more embodiments of the present disclosure, determining the at least two initial images according to the posture similarity corresponding to each of the material images includes: determining a material image having a posture similarity greater than a first similarity threshold as the initial image, and/or determining a material image having a posture similarity less than a second similarity threshold as the initial image; where the first similarity threshold is greater than the second similarity threshold.

According to one or more embodiments of the present disclosure, the method further includes: obtaining dynamic definitions corresponding to the material images; performing frame extraction on the material data according to the image content of the material images in the material data to obtain the at least two initial images includes: obtaining the at least two initial images based on the image content of each of the material images and a corresponding dynamic definition.

According to one or more embodiments of the present disclosure, performing the image style migration respectively on the at least two initial images to obtain the corresponding target image frames each having a target image style includes: obtaining a style migration model corresponding to the target image style; and processing the initial images based on the style migration model to obtain the target image frames corresponding to the initial images.

According to one or more embodiments of the present disclosure, processing the initial images based on the style migration model to obtain the target image frames corresponding to the initial images includes: determining target image elements in the initial images based on image content of the initial images; performing edge cropping around the target image elements to obtain cropped images containing the target image elements, where a proportion of an image area of a target image element in a cropped image is greater than a proportion of an image area of the target image element in the initial image; and performing style migration on each of the cropped images based on the style migration model corresponding to the target image style, to obtain the target image frames corresponding to the initial images.

According to one or more embodiments of the present disclosure, the method further includes: before performing the image style migration respectively on the at least two initial images to obtain the corresponding target image frames each having the target image style, determining the target image style based on the image content corresponding to the at least two initial images.

According to one or more embodiments of the present disclosure, the target stitched image includes at least two stitched image areas, each of the stitched image areas is configured to display one corresponding target image frame, and the target stitched image layout represents sizes and/or positions of the stitched image areas in the target stitched image.

According to one or more embodiments of the present disclosure, determining the target stitched image layout according to the image content corresponding to the at least two initial images includes: obtaining context information according to the image content corresponding to the at least two initial images, the context information representing a context relationship between the image content corresponding to the at least two initial images; and determining the target stitched image layout according to the context information.

According to one or more embodiments of the present disclosure, the method further includes: adding special effect identifiers to the target image frames to obtain special effect target image frames, where the special effect identifiers are determined based on image content of the target image frames.

According to one or more embodiments of the present disclosure, adding the special effect identifiers to the target image frames to obtain the special effect target image frames includes: performing facial feature detection on character elements in the target image frames to obtain corresponding facial expression features; determining corresponding target special effect identifiers based on the facial expression features; determining target display positions of the target special effect identifiers; and adding the target special effect identifiers to the target image frames based on the target display positions to obtain special effect target image frames.

According to a second aspect, there is provided an apparatus for image generation according to one or more embodiments of the present disclosure, including:
an obtaining module configured to obtain at least two initial images;
a migration module configured to perform image style migration respectively on the at least two initial images to obtain corresponding target image frames each having a target image style; and
a combination module configured to determine a target stitched image layout according to image content corresponding to the at least two initial images, and combine the at least two target image frames according to the target stitched image layout to generate a target stitched image.

In a possible implementation, the obtaining module is specifically configured to: obtain material data, the material data including a video and/or a picture set; perform frame extraction on the material data according to image content of material images in the material data to obtain the at least two initial images, the material images being video frames in the video and/or pictures in the picture set.

In one possible implementation, the obtaining module is configured to obtain, when performing frame extraction on the material data according to the image content of the material images in the material data to obtain the at least two initial images, a posture similarity corresponding to a material image based on image content of the material image, the posture similarity representing a similarity between a posture of a character element in the image content and a target posture; and determine the at least two initial images according to the posture similarity corresponding to each of the material images.

In a possible implementation, when determining the at least two initial images according to the posture similarity corresponding to each of the material images, the obtaining module is specifically configured to: determine a material image having a posture similarity greater than a first similarity threshold as the initial image, and/or determine a material image having a posture similarity less than a second similarity threshold as the initial image; where the first similarity threshold is greater than the second similarity threshold.

In one possible implementation, the obtaining module is further configured to obtain dynamic definitions corresponding to the material images; when performs frame extraction on the material data according to the image content of the material images in the material data to obtain the at least two initial images, specifically configured to: obtain the at least two initial images based on image content of each of the material images and a corresponding dynamic definition.

In a possible implementation, the migration module is specifically configured to: a style migration model corresponding to the target image style; and process the initial images based on the style migration model to obtain the target image frames corresponding to the initial images.

In a possible implementation, when processing the initial images based on the style migration model to obtain the target image frames corresponding to the initial images, the migration module is specifically configured to: determine target image elements in the initial images based on image content of the initial images; perform edge cropping around the target image elements to obtain cropped images containing the target image elements, where a proportion of an image area of a target image element in a cropped image is greater than a proportion of an image area of the target image element in the initial image; perform style migration on each of the cropped images based on the style migration model corresponding to the target image style, to obtain the target image frames corresponding to the initial images.

In a possible implementation, the migration module is further configured to determine, before performing the image style migration respectively on the at least two initial images to obtain the corresponding target image frames each having the target image style, the target image style based on image content corresponding to the at least two initial images.

In a possible implementation, the target stitched image includes at least two stitched image areas, where each of the stitched image areas is configured to display one corresponding target image frame, and the target stitched image layout represents sizes and/or positions of the stitched image areas in the target stitched image.

In a possible implementation, when determining the target stitched image layout according to the image content corresponding to the at least two initial images, the combination module is specifically configured to: obtain context information according to the image content corresponding to the at least two initial images, the context information representing a context relationship between the image content corresponding to the at least two initial images; and determine the target stitched image layout according to the context information.

In a possible implementation, the combination module is further configured to add special effect identifiers to the target image frames to obtain special effect target image frames, where the special effect identifiers are determined based on image content of the target image frames.

In a possible implementation, when adding the special effect identifiers to the target image frames to obtain the special effect target image frames, the combination module is specifically configured to: perform facial feature detection on character elements in the target image frames to obtain corresponding facial expression features; determine corresponding target special effect identifiers based on the facial expression features; determining target display positions of the target special effect identifiers; and add the target special effect identifiers to the target image frames based on the target display positions to obtain special effect target image frames.

According to a third aspect, according to one or more embodiments of the present disclosure, there is provided an electronic device, including: a processor and a memory communicatively connected to the processor;
the memory stores computer execution instructions;
the processor executes the computer-executable instructions stored in the memory, so as to implement the method for image generation according to the foregoing first aspect and various possible designs of the first aspect.

According to a fourth aspect, a computer readable storage medium is provided according to one or more embodiments of the present disclosure. The computer readable storage medium stores computer execution instructions therein. When the processor executes the computer execution instruction, the method for image generation according to the first aspect and various possible designs of the first aspect is implemented.

According to a fifth aspect, an embodiment of the present disclosure provides a computer program product, including a computer program which, when executed by a processor, implements the method for image generation according to the first aspect and various possible designs of the first aspect.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations is depicted in a specific order, this should not be understood as requiring these operations to be performed in the specific order shown or in a sequential order. In certain environments, multitasking and parallel processing may be advantageous. Similarly, although a plurality of implementation details is included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

1-16. (canceled)

17. A method for image generation, comprising:
obtaining at least two initial images;
performing image style migration respectively on the at least two initial images to obtain corresponding target image frames each having a target image style;
determining a target stitched image layout according to image content corresponding to the at least two initial images; and
combining the at least two target image frames according to the target stitched image layout to generate a target stitched image.

18. The method of claim 17, wherein obtaining the at least two initial images comprises:
obtaining material data, the material data comprising a video and/or a picture set; and
performing the frame extraction on the material data according to image content of material images in the material data to obtain the at least two initial images, the material images being video frames in the video and/or pictures in the picture set.

19. The method of claim 18, wherein performing the frame extraction on the material data according to the image content of the material images in the material data to obtain the at least two initial images comprises:
obtaining a posture similarity corresponding to a material image based on image content of the material image, the posture similarity representing a similarity between a posture of a character element in the image content and a target posture; and
determining the at least two initial images according to the posture similarity corresponding to each of the material images.

20. The method of claim 19, wherein determining the at least two initial images according to the posture similarity corresponding to each of the material images comprises:
determining a material image with a posture similarity greater than a first similarity threshold as the initial image; and/or
determining a material image with a posture similarity less than a second similarity threshold as the initial image;
wherein the first similarity threshold is greater than the second similarity threshold.

21. The method of claim 18, further comprising:
obtaining dynamic definitions corresponding to the material images;
performing the frame extraction on the material data according to the image content of the material images in the material data to obtain the at least two initial images comprising:
obtaining the at least two initial images based on the image content of each of the material images and a corresponding dynamic definition.

22. The method of claim 17, wherein performing the image style migration respectively on the at least two initial images to obtain the corresponding target image frames each having a target image style comprises:
obtaining a style migration model corresponding to the target image style; and
processing the initial images based on the style migration model to obtain the target image frames corresponding to the initial images.

23. The method of claim 22, wherein processing the initial images based on the style migration model to obtain the target image frames corresponding to the initial images comprises:
determining target image elements in the initial images based on image content of the initial images;
performing edge cropping around the target image elements to obtain cropped images containing the target image elements, wherein a proportion of an image area of a target image element in a cropped image is greater than a proportion of an image area of the target image element in the initial image; and
performing style migration on each of the cropped images based on the style migration model corresponding to the target image style, to obtain the target image frames corresponding to the initial images.

24. The method of claim 17, further comprising: before performing the image style migration respectively on the at least two initial images to obtain the corresponding target image frames each having the target image style,
determining the target image style based on the image content corresponding to the at least two initial images.

25. The method of claim 17, wherein the target stitched image comprises at least two stitched image areas, each of the stitched image areas is configured to display one corresponding target image frame, and the target stitched image layout represents sizes and/or positions of the stitched image areas in the target stitched image.

26. The method of claim 17, wherein determining the target stitched image layout according to the image content corresponding to the at least two initial images comprises:
obtaining context information according to the image content corresponding to the at least two initial images, the context information representing a context relationship between the image content corresponding to the at least two initial images; and
determining the target stitched image layout according to the context information.

27. The method of claim 17, further comprising:
adding special effect identifiers to the target image frames to obtain special effect target image frames, wherein the special effect identifiers are determined based on image content of the target image frames.

28. The method of claim 27, wherein adding the special effect identifiers to the target image frames to obtain the special effect target image frames comprises:
performing facial feature detection on character elements in the target image frames to obtain corresponding facial expression features;
determining corresponding target special effect identifiers based on the facial expression features;
determining target display positions of the target special effect identifiers; and
adding the target special effect identifiers to the target image frames based on the target display positions to obtain the special effect target image frames.

29. An electronic device, comprising:
a processor, and a memory communicatively connected to the processor;
the memory stores computer execution instructions;
the processor executes the computer execution instructions stored in the memory, so as to implement the method for image generation, comprising:
obtaining at least two initial images;
performing image style migration respectively on the at least two initial images to obtain corresponding target image frames each having a target image style;
determining a target stitched image layout according to image content corresponding to the at least two initial images; and
combining the at least two target image frames according to the target stitched image layout to generate a target stitched image.

30. The electronic device of claim 29, wherein obtaining the at least two initial images comprises:
obtaining material data, the material data comprising a video and/or a picture set; and
performing the frame extraction on the material data according to image content of material images in the material data to obtain the at least two initial images, the material images being video frames in the video and/or pictures in the picture set.

31. The electronic device of claim 30, wherein performing the frame extraction on the material data according to the image content of the material images in the material data to obtain the at least two initial images comprises:
obtaining a posture similarity corresponding to a material image based on image content of the material image, the posture similarity representing a similarity between a posture of a character element in the image content and a target posture; and
determining the at least two initial images according to the posture similarity corresponding to each of the material images.

32. The electronic device of claim 31, wherein determining the at least two initial images according to the posture similarity corresponding to each of the material images comprises:
determining a material image with a posture similarity greater than a first similarity threshold as the initial image; and/or
determining a material image with a posture similarity less than a second similarity threshold as the initial image;
wherein the first similarity threshold is greater than the second similarity threshold.

33. The electronic device of claim 30, further comprising:
obtaining dynamic definitions corresponding to the material images;
performing the frame extraction on the material data according to the image content of the material images in the material data to obtain the at least two initial images comprising:
obtaining the at least two initial images based on the image content of each of the material images and a corresponding dynamic definition.

34. The electronic device of claim 29, wherein performing the image style migration respectively on the at least two initial images to obtain the corresponding target image frames each having a target image style comprises:
obtaining a style migration model corresponding to the target image style; and
processing the initial images based on the style migration model to obtain the target image frames corresponding to the initial images.

35. The electronic device of claim 34, wherein processing the initial images based on the style migration model to obtain the target image frames corresponding to the initial images comprises:
determining target image elements in the initial images based on image content of the initial images;
performing edge cropping around the target image elements to obtain cropped images containing the target image elements, wherein a proportion of an image area of a target image element in a cropped image is greater than a proportion of an image area of the target image element in the initial image; and
performing style migration on each of the cropped images based on the style migration model corresponding to the target image style, to obtain the target image frames corresponding to the initial images.

36. A non-transitory computer readable storage medium, wherein, the computer readable storage medium stores computer execution instructions therein, and when executed by a processor, the computer execution instructions implement the method for image generation, comprising:
obtaining at least two initial images;
performing image style migration respectively on the at least two initial images to obtain corresponding target image frames each having a target image style;
determining a target stitched image layout according to image content corresponding to the at least two initial images; and
combining the at least two target image frames according to the target stitched image layout to generate a target stitched image.
